(19) United States
(12) Patent Application Publication
(10) Pub. No.: US 2026/0152009 A1
(43) Pub. Date: Jun. 4, 2026

(54) PRINTING APPARATUS, CONTROL METHOD, AND STORAGE MEDIUM

(71) Applicant: CANON KABUSHIKI KAISHA, Tokyo (JP)

(72) Inventors: AKIKO AICHI, Tokyo (JP); AKIKO YASUDA, Kanagawa (JP); TAKAO OGATA, Tokyo (JP); KEITA ISHIMI, Kanagawa (JP)

(21) Appl. No.: 19/351,732

(22) Filed: Oct. 7, 2025

(30) Foreign Application Priority Data
Oct. 8, 2024 (JP) 2024-176735

(51) Int. Cl. B41J 2/21; B41J 11/00; B41J 11/06

(52) U.S. Cl. CPC B41J 2/2114; B41J 2/2103; B41J 11/0065; B41J 11/06

(57) ABSTRACT

A printing apparatus includes a printing unit, a platen, and a control unit. The control unit executes discharge control to discharge, to a liquid discharged to the platen in a printing operation, a liquid of a type different from the liquid discharged to the platen after the printing operation. The discharge control is performed such that a second type of liquid is discharged to a first type of liquid discharged in the printing operation, and a fourth type of liquid is discharged to a third type of liquid discharged in the printing operation. The second type of liquid has a higher deposition suppression effect for a component of the first type of liquid than the fourth type of liquid. The fourth type of liquid has a higher deposition suppression effect for a component of the third type of liquid than the second type of liquid.

### BACKGROUND

### Field of the Technology

The present disclosure relates to a printing apparatus.

### Description of the Related Art

In a printing apparatus that prints an image on a print medium by discharging ink, ink sometimes adheres onto the platen facing a printing head. For example, in executing borderless printing, ink is landed not only on a print medium but also on a region outside an end portion of the print medium so as to protrude from the end portion. The deposition of a component of ink adhering to the platen causes contamination on a print medium and contact with a printing head. Accordingly, there has been proposed a technique of suppressing the deposition of ink components on the platen by discharging ink having an effect of suppressing ink deposition to the ink adhering to the platen (for example, Japanese Patent Laid-Open No. 2012-51198).

The conventional technique has room for improvement in deposition suppression.

### SUMMARY

The present disclosure provides a technique of suppressing the deposition of liquid components discharged onto a platen.

According to an aspect of the present disclosure, there is provided a printing apparatus comprising: a printing unit configured to discharge a plurality of types of liquids to a print medium; a platen arranged to face the printing unit and configured to support the print medium; and a control unit configured to control the printing unit, wherein the control unit executes discharge control to discharge, to a liquid discharged to the platen in a printing operation, a liquid of a type different from the liquid discharged to the platen after the printing operation, the discharge control is performed such that a second type of liquid is discharged to a first type of liquid discharged to the platen in the printing operation, and a fourth type of liquid is discharged to a third type of liquid discharged to the platen in the printing operation, the second type of liquid is a liquid having a higher deposition suppression effect for a component of the first type of liquid than the fourth type of liquid, and the fourth type of liquid is a liquid having a higher deposition suppression effect for a component of the third type of liquid than the second type of liquid.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic view of a printing apparatus according to one embodiment of the present disclosure;

FIG. 2 is a plan view of a platen;

FIG. 3 is an exploded perspective view of a carriage and a plurality of ink tanks;

FIG. 4 is a view showing the arrangement of the nozzle group of a printing head;

FIG. 5 is a block diagram of the control circuit of the printing apparatus;

FIG. 6 is a view showing an example of an ink discharge region in borderless printing;

FIG. 7 is a view showing the result of an experiment of specifying deposition-prone inks;

FIG. 8 is a view showing the result of an experiment of specifying a deposition suppression ink;

FIG. 9 is a view showing a relationship between deposition-prone inks and deposition suppression inks;

FIG. 10 is a graph showing an example of the classification of use environments of the printing apparatus;

FIGS. 11A and 11B are views for explaining weighting coefficients;

FIG. 12 is a flowchart showing an example of control;

FIG. 13 is a view showing an example of the amounts of inks discharged to each region;

FIG. 14 is a view showing the result of an experiment of specifying a deposition-prone ink;

FIG. 15 is a view showing the result of an experiment concerning the occurrence of deposition due to combinations of inks;

FIG. 16 is a view showing the result of an experiment concerning deposition heights associated with combinations of two types of inks;

FIG. 17 is a view showing the relationship between two types of deposition-prone inks and a deposition suppression ink;

FIGS. 18A and 18B show an example of ink discharge regions in borderless printing;

FIG. 19 is a flowchart showing an example of control;

FIG. 20 is a view showing an example of the amounts of inks discharged to each region; and

FIG. 21 is a view showing an example of the amounts of inks discharged to each region.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Arrangement of Apparatus

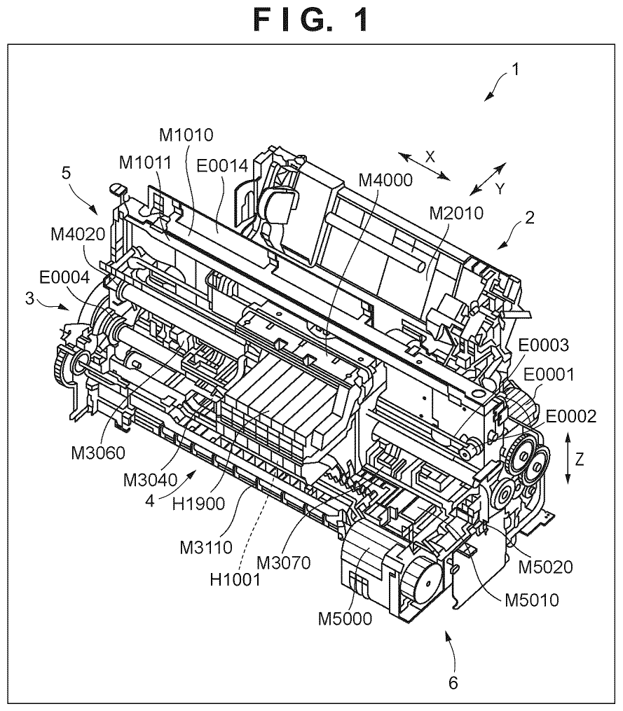

FIG. 1 is a schematic view of a printing apparatus 1 according to one embodiment of the present disclosure. Although the present embodiment will exemplify a case where the present disclosure is applied to a serial type inkjet printing apparatus, the present disclosure can also be applied to printing apparatuses of other forms.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

In the drawings, arrows X, Y, and Z indicate directions crossing each other. The arrows X and Y indicate horizontal directions that are orthogonal to each other, and the arrow Z indicates the up/down direction. The X direction corresponds to the left/right direction (the lateral direction or the widthwise direction) of the printing apparatus 1, and the Y direction corresponds to the front/rear direction (the depth direction) of the printing apparatus 1. The Z direction corresponds to the height direction (up/down direction) of the printing apparatus 1. Also, the downstream side and the upstream side are defined based on the conveyance direction of a print medium as a reference.

The printing apparatus 1 includes a feed unit 2, a convey unit 3, a discharge unit 4, a drive unit 5, and a cleaning unit 6.

The feed unit 2 has a mechanism that separates print media stacked on a pressure plate M2010 one by one and feeds each print medium to a platen M3040.

The convey unit 3 includes a convey roller M3060, a pinch roller M3070 that comes into pressure contact with the convey roller M3060, and a convey motor E0004 that is a drive source for rotating the convey roller M3060. The print medium fed from the feed unit 2 is clamped between the convey roller M3060 and the pinch roller M3070 and conveyed to a printing head M1001 in the sub-scanning direction (Y direction).

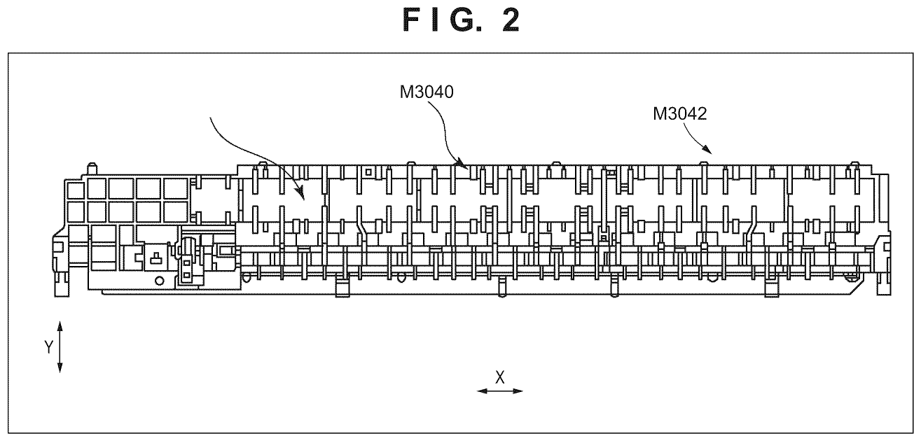

The platen M3040 is placed to face the printing head M1001 and supports a print medium. FIG. 2 is a plan view of the platen M3040. The platen M3040 includes a base member M3042 having a plate-like shape as a whole and an absorber M3041 provided on the base member M3042. The absorber M3041 absorbs the liquid that has been discharged from the printing head M1001 and has not been landed on a print medium.

Referring back to FIG. 1, the discharge unit 4 includes a paper discharge roller M3110, and a plurality of spurs and discharges a print medium from a printing region of the printing head M1001.

The printing head M1001 is mounted on a carriage M4000. The drive unit 5 is a mechanism that reciprocates the printing head M1001 in the main scanning direction (X direction) by moving the carriage M4000. The drive unit 5 includes a guide shaft M4020 and a guide rail M1011 which extend in the X direction and guide the movement of the carriage M4000.

The drive unit 5 includes a carriage motor E0001 attached to a chassis M1010. The carriage motor E0001 rotates a driving pully E0002 supported on one end portion of the chassis M1010 in the X direction. The other end portion of the chassis M1010 in the X direction is provided with a driven pulley (not shown). A timing belt E0003 is wound around the driving pully E0002 and the driven pulley. The carriage M4000 is fixed to the timing belt E0003. As the carriage motor E0001 drives the timing belt E0003, the carriage M4000 moves.

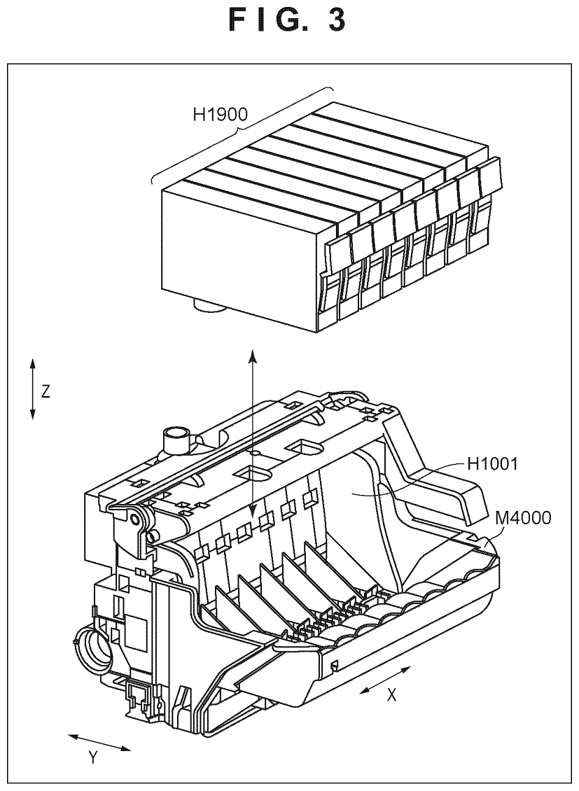

A printing head H1001 forms an image by discharging liquid to a print medium. In the present embodiment, the printing head H1001 discharges a plurality of types of inks. The carriage M4000 is provided with a plurality of ink tanks H1900 storing inks discharged by the printing head H1001. FIG. 3 is an exploded perspective view of the carriage M4000 and the plurality of ink tanks H1900.

The printing head H1001 is detachable from the carriage M4000. While the printing head H1001 is mounted on the carriage M4000, the ink tank H1900 is detachable from the printing head H1001. FIG. 3 shows an example of an arrangement that allows the eight ink tanks H1900 to be mounted on the carriage M4000. The respective ink tanks H1900 respectively store different types of inks. Accordingly, the present embodiment is configured to allow eight types of inks to be discharged from the printing heads H1001.

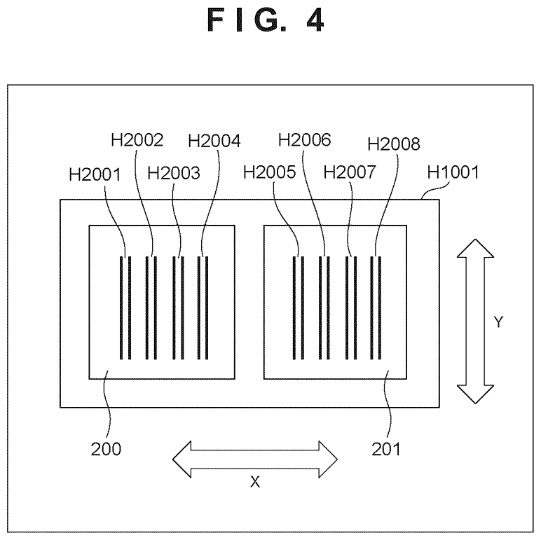

The printing head H1001 has nozzles (orifices) that discharge inks for the respective types of inks. FIG. 4 shows the arrangement of the nozzle group of the printing head H1001. The printing head H1001 has nozzle arrays H2001, H2002, H2003, H2004, H2005, H2006, H2007, and H2008. The respective nozzle arrays respectively correspond to the different types of inks. These nozzle arrays are arranged in the main scanning direction (X direction) of the printing head H1001. Each of the nozzle arrays H2001 to H2008 is constituted by 768 nozzles arranged side by side at intervals of, for example, 1,200 dpi (dots/inch) in the sub-scanning direction (Y direction). One nozzle discharges an ink droplet of about 3 pl per discharge.

Referring back to FIG. 1, the cleaning unit 6 performs the processing associated with the maintenance and recovery of the discharge performance of the printing head H1001. The cleaning unit 6 according to the present embodiment is provided with two caps M5010. One cap M5010 has a size that covers the nozzle arrays H2001 to H2004. The other cap M5010 has a size that covers the nozzle arrays H2005 to H2008. When performing preliminary discharge with respect to the cap M5010, the printing head H1001 can discharge ink to the cap M5010.

A hole (not shown) having a diameter of about 0.5 mm is formed in the cap M5010, and a tube (not shown) is connected to an outside of the cap M5010 through the hole. The tube is connected to a pump M5000. Suction is performed by the pump M5000 to clean the inside of the printing head H1001. Using a wiper M5020 makes it possible to remove dust and adhering ink by wiping the nozzle surfaces (ink orifice surfaces) of the printing head H1001.

An electric control board E0014 includes the control circuit of the printing apparatus 1. The control circuit controls, for example, a printing operation for an image on a print medium. In the process of movement of the carriage M4000 in the main scanning direction, the printing head H1001 discharges ink onto a print medium to print an image. This operation is called a printing scan. A printing operation is performed by alternately repeating a conveying operation of intermittently conveying a print medium in the sub-scanning direction by the convey unit 3 and a printing scan.

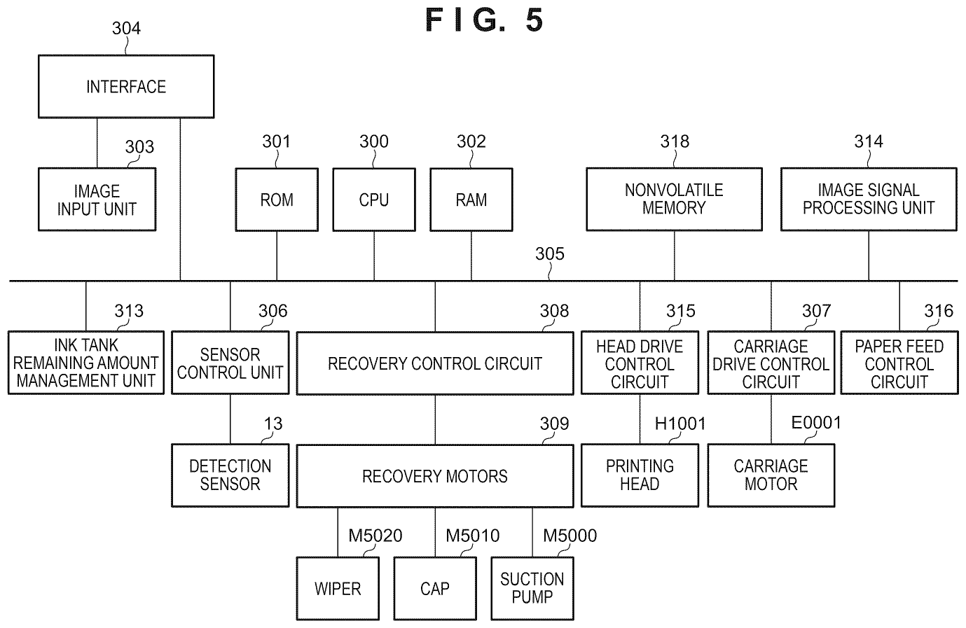

FIG. 5 is a block diagram of the control circuit. The control circuit includes a CPU 300, a ROM 301, and a RAM 302. The CPU 300 is a processor that controls the printing apparatus 1 by executing a program stored in the ROM 301. The processing executed by the CPU 300 includes data processing of print data, drive control of the printing head H1001, movement control of the carriage M4000, conveyance control of a print medium, and cleaning control of the printing head H1001.

The ROM 301 and the RAM 302 are storage devices and are semiconductor memories in particular. The RAM 302 is used as a work area for data processing and the like by the CPU 300 and temporarily holds discharge data of a plurality of scans, parameters associated with a recovery processing operation and a supply operation of the inkjet printing apparatus, and the like. An interface 304 can connect a host apparatus to the printing apparatus 1. The CPU 300 performs communication processing with the host apparatus via the interface 304. The host apparatus is a personal computer or portable terminal used by the user.

A nonvolatile memory 318 can store information indicating the amount of ink stored in a waste ink storage body (not shown), the amount of ink discharged to the platen absorber M3041, discharge times, ink information, and the like and can hold the information even after the power source of the printing apparatus 1 is tuned off. The amount of ink discharged to the platen absorber M3041 is measured by counting the discharge count that ink is discharged to outside a print medium based on image data. The amount of ink stored in the waste ink storage body is calculated by counting the discharge count that ink is discharged to the platen absorber M3041 and the cap M5010 and multiplying the counted ink amount by an evaporation coefficient.

An ink tank remaining amount management unit 313 manages information indicating the remaining amount of each ink tank H1900 based on the ink information stored in the nonvolatile memory 318. The CPU 300 causes the display unit of the host apparatus to display a warning for the replacement of ink when the remaining amount of the ink tank H1900 stored in the ink tank remaining amount management unit 313 becomes equal to or less than a predetermined amount. A sensor control unit 306 causes a detection sensor 13 that measures temperature and humidity to operate at a predetermined timing to acquire the temperature and humidity of the use environment of the printing apparatus 1.

A recovery control circuit 308 performs the drive control of recovery motors 309 and controls recovery operations such as the upward/downward operation of the cap M5010, the operation of the wiper M5020, and the operation of the suction pump M5000.

An image input unit 303 temporarily holds the image data input from the host apparatus via the interface 304. An image signal processing unit 314 performs predetermined image processing for the image data input to the image input unit 303 to generate discharge data used to discharge ink in a printing operation. The printing head H1001 and the carriage M4000 are controlled in accordance with the discharge data.

A head drive control circuit 315 drives printing elements of the printing head H1001. Driving the printing elements will cause the printing head H1001 to discharge ink and preliminarily discharge ink. Such printing element is provided for each nozzle and is, for example, a heat generating element that causes ink to be discharged from the nozzle using heat energy and an electricity-heat exchanging element that generates heat upon receiving an electrical signal.

A carriage drive control circuit 307 controls the reciprocal movement of the carriage M4000 in the main scanning direction (X direction) by driving the carriage motor E0001. A paper feed control circuit 316 controls the drive of the convey motor E0004 in accordance with a program stored in the RAM 302.

### Borderless Printing

In the present embodiment, it is possible to perform borderless printing in addition to printing with margins left on the edges of a print medium. In borderless printing, an image is printed up to the edges of a print medium. In order to eliminate the margins on the edges of a print medium, ink is discharged up to regions protruding from the edges of the print medium. The discharged ink is landed on the platen M3040.

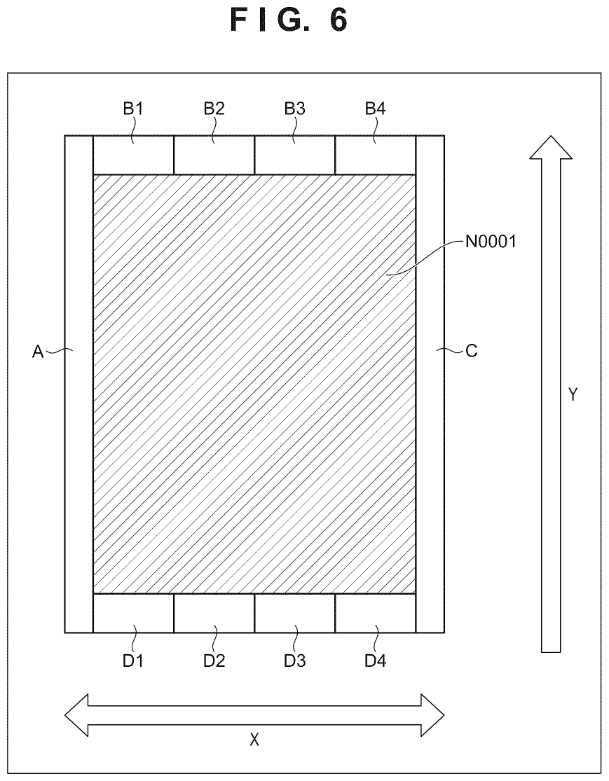

FIG. 6 shows an example of ink discharge regions (protrusion regions) in borderless printing. In order to leave no margins on a print medium N0001 after printing, discharge regions A to D4 are set along the end portions of the print medium N0001. Region A is a region on the right side of the print medium N0001. Regions B1 to B4 are regions on the leading end side of the print medium N0001 in the conveyance direction. Region C is a region on the left side of the print medium N0001. Regions D1 to D4 are regions are regions on the trailing end side of the print medium N0001 in the conveyance direction.

For example, the respective regions have the following widths: region A: 2.8 mm; regions B1 to B4: 2.0 mm; region C: 2.8 mm; and regions D1 to D4: 1.8 mm. These widths are set so as to leave no margins on the print medium N0001 in consideration of feed errors, conveyance errors, and the maximum amount of skew of the print medium N0001. Note that the user may be allowed to select protrusion amounts step by step.

Ink protruding from the print medium N0001 is discharged onto the platen absorber M3041 (FIG. 2). The amount of ink discharged from the print medium N0001 in a protruding manner is calculated by counting the discharge count (dot count) that ink is discharged to each of regions A to D4.

### Example of Types of Inks and Deposition

An example of the types of inks stored in the eight ink tanks H1900 will be described. The inks to be used include pigment inks. The present embodiment is based on the assumption of using a total of eight types of inks including matte black ink, photo black ink, magenta ink, yellow ink, cyan ink, light magenta ink, light cyan ink, and clear ink containing no pigment and used for image quality improvement.

In this case, matte black ink is black ink that exhibits excellent chromogenic property on a print medium such as plain paper having no ink absorbing layer or coated paper. Photo black ink is a black ink that has excellent surface smoothness and exhibits excellent chromogenic property on a print medium such as glossy paper having an ink absorbing layer. Although the present embodiment will be described on the assumption that pigment inks are used, the present disclosure can also be applied dye inks.

An ink component discharged onto the platen absorber M3041 is sometimes deposited. Assume that borderless printing is executed, and ink is discharged onto the platen absorber M3041. In this case, an ink component remains on a surface of the platen absorber M3041 without penetrating in the platen absorber M3041. As borderless printing is repeated, residual components are accumulated and deposited. This phenomenon is sometimes called ink deposition.

Ink deposition can occur on a platen without the platen absorber M3041. In the absence of the platen absorber M3041, ink used in borderless printing is discharged to a member corresponding to a base member M3042. This member is provided with a slope, a groove, a hole, or the like so as to discharge ink while preventing it from remaining on the platen. If, however, for example, ink decreases in fluidity, the ink remains on the platen. This eventually causes ink deposition.

Inks that are prone to cause a deposition phenomenon include, for example, an ink containing a color material with low solubility and an ink that greatly increases in viscosity and decreases in fluidity at the time of evaporation. Such an ink having the property of being deposited is sometimes called a deposition-prone ink. On the other hand, there are inks that have effects of reducing deposition when they are mixed with deposition-prone inks or applied on deposition-prone inks. Such inks are sometimes called deposition suppression inks.

### Suppression of Ink Deposition

Sometimes different inks exhibit deposition suppression effects with respect to different deposition-prone inks. Accordingly, if a single deposition suppression ink is used for a plurality of types of deposition-prone inks, deposition suppression cannot be sometimes effectively achieved. The present embodiment is configured to select a deposition suppression ink with high deposition suppression effect from a plurality of types of deposition suppression inks with respect to a deposition-prone ink and discharge the selected ink.

In this case, experiment 1 described below makes it possible to determine whether a given ink is a deposition-prone ink. A device that drops ink on the platen absorber M3041 is installed to intermittently drop a target ink under a high-temperature/low-humidity environment. This makes it possible to determine whether the target ink is a deposition-prone ink by determining whether a sediment is formed on the platen absorber M3041 after a given prescribed drop count.

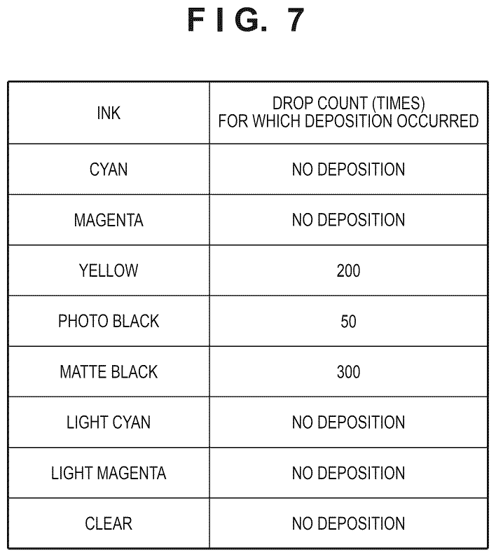

Measuring a drop count that has formed a sediment of the target ink can evaluate the deposition proneness of each target ink. An ink that is deposited with a smaller drop count can be regarded as an ink that is more prone to be deposited. In experiment 1, ink was dropped on the platen absorber M3041 at 600 dpi×600 dpi (vertical×horizontal) and a density of 120 ng at 1-hour intervals under an environment with a temperature of 30° C. and a humidity of 10%. Ink dropping was executed up to 500 times. FIG. 7 shows, in a table form, an experiment result indicating whether sediments are formed after ink dropping. According to this result, inks that are deposited with smaller drop counts are deposition-prone inks. This experiment shows that inks are more prone to be deposited in the order of photo black ink>yellow ink>matte black ink.

Subsequently, experiment 2 was conducted to perform measurement to determine, with respect to each deposition-prone ink determined in experiment 1, which ink had a deposition suppression effect and how much ink was required to achieve deposition suppression. In experiment 2, a device that drops ink on the platen absorber M3041 is installed. Under a high-temperature/low-humidity environment, each deposition-prone ink determined in experiment 1 is dropped first, and a deposition suppression candidate ink is then dropped.

Tests are conducted concerning a plurality of amounts of tests to determine how many times the amount of each deposition-prone ink a corresponding test ink is to be dropped. An operation of dropping such a deposition-prone ink and an operation of dropping a deposition suppression ink candidate are set as one set and repeatedly executed at predetermined time intervals. It is possible to determine how much test ink should be dropped to achieve deposition suppression depending on whether a sediment is formed on the platen absorber M3041 after the execution of tests by a predetermined set count. Alternatively, it is possible to determine whether the amount of ink tested cannot achieve deposition suppression.

In the present embodiment, photo black ink, yellow ink, and matte black inks which are deposited in experiment 1 are determined as deposition-prone inks, and deposition suppression candidate inks for the respective deposition-prone inks are cyan ink, magenta ink, light cyan ink, light magenta ink, and clear ink.

A deposition-prone ink was dropped on the platen absorber M3041 at 600 dpi×600 dpi (vertical x horizontal) and a density of 120 ng under an environment with a temperature of 30° C. and a humidity of 10%. Immediately after this operation, a deposition suppression candidate ink was dropped 0.5 times, 1 time, 2 times, 4 times, 6 times, 8 times, and 10 times the amount of deposition-prone ink. The above step was repeatedly performed a total of 500 times at 1-hr intervals.

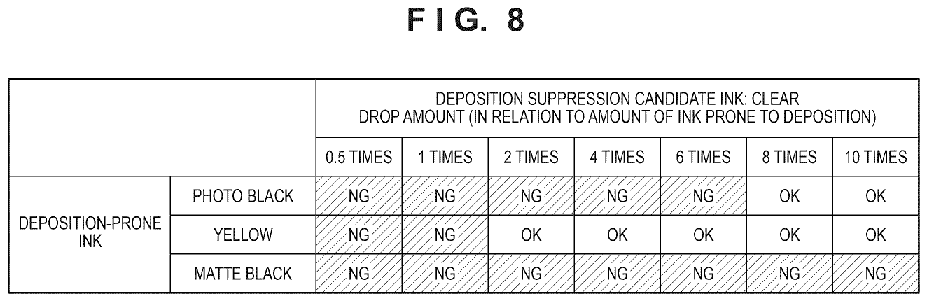

FIG. 8 shows the experiment result obtained by using clear ink as a deposition suppression ink candidate. If a sediment is formed on the platen absorber M3041 at the end of 500 steps, “NG” is recorded; otherwise, “OK” is recorded.

This result shows that the dropping of clear ink 6 or less times the amount of photo black ink causes deposition, but the dropping of clear ink 8 or more times the amount of photo black ink causes no deposition. This makes it possible to determine that the dropping of clear ink 8 times the amount of photo black ink can suppress the deposition of photo black ink. Likewise, the deposition of yellow ink can be suppressed by clear ink 2 times the amount of yellow ink. The deposition of matte black ink cannot be suppressed by the clear ink 10 or less times the amount of matte black ink. Similar experiments are conducted with respect to other deposition suppression ink candidates.

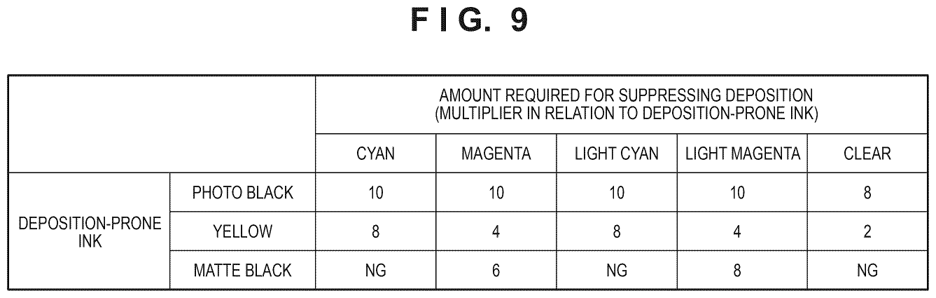

FIG. 9 shows a summary of the above experiment results. FIG. 9 shows how many times the amount of each deposition-prone ink a corresponding deposition suppression ink candidate was dropped to achieve deposition suppression. When a given ink is deposited even after the dropping of a deposition suppression ink candidate of an amount 10 times the given ink, “NG” is recorded.

Smaller numerical values indicate that deposition suppression can be achieved by smaller amounts of inks, and that higher deposition suppression effects are achieved. The result shown in FIG. 9 indicates that clear ink exhibits high deposition suppression effects with respect to photo black ink and yellow ink, but cannot achieve deposition suppression with respect to matte black ink. Magenta ink exhibits a high deposition suppression effect with respect to matte black ink. Accordingly, clear ink is selected as a deposition suppression ink for photo black ink and yellow ink, and magenta ink is selected as a deposition suppression ink for matte black ink.

As described above, an ink exhibiting a high deposition suppression effect is not always the same with respect to deposition-prone inks among the plurality of types of inks used in the printing apparatus 1. Therefore, selecting a deposition suppression ink depending on a deposition-prone ink makes it possible to more effectively suppress ink deposition.

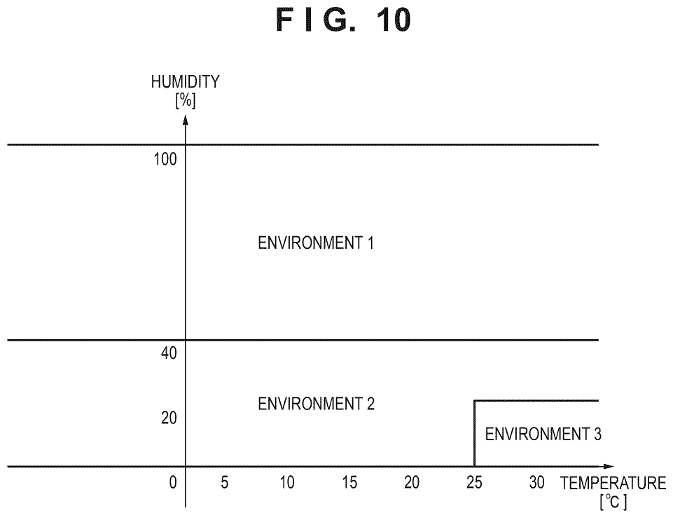

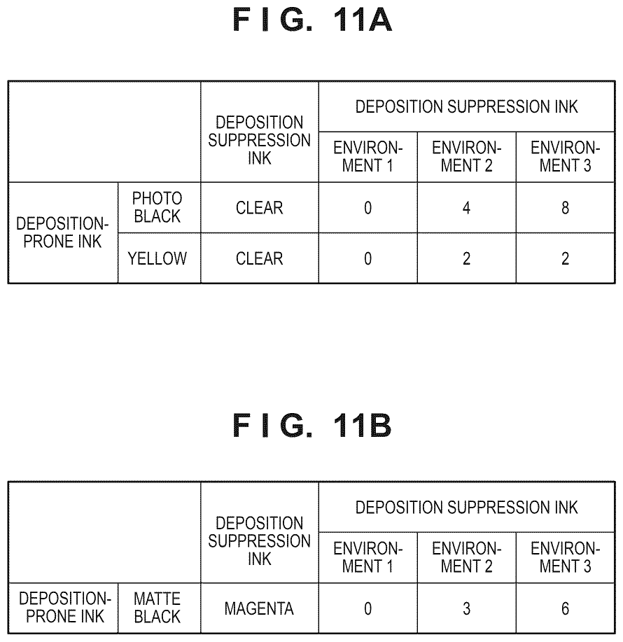

In addition, experiment 1 and experiment 2 greatly depend on the temperature and humidity of the operating environment of the printing apparatus 1. This is because the higher the temperature and the lower the humidity of the environment, the faster the ink on the platen absorber M3041 dries and increases in viscosity. For this reason, different temperatures and humidities were set in three environments (environments 1 to 3) as shown in FIG. 10, and experiment 1 and experiment 2 were conducted in each environment. In each environment, the amounts of inks required for deposition suppression discharge were calculated. FIGS. 11A and 11B show summaries of these results. FIG. 11A shows a case where clear ink is a deposition suppression ink. FIG. 11B shows case where magenta ink is a deposition suppression ink.

Assume that a printing operation was performed in an environment with a temperature of 30° C. and a humidity of 10%. In this case, the environment corresponds to “environment 3” in FIG. 10, and hence clear ink eight times the amount of photo black ink that landed on the platen absorber is discharged at the photo black ink landing position from FIG. 11. When yellow ink was landed on the platen absorber, clear ink 2 times the amount of yellow ink is discharged to the same position on the platen absorber. When matte black ink was landed on the platen absorber, magenta ink 6 times the amount of matte black ink is discharged. When a printing operation was performed in an environment with a temperature of 20° C. and a humidity of 50%, the environment corresponds to “environment 1”, in which no deposition occurs, and hence no deposition suppression discharge is performed. The amounts of ink required for deposition suppression discharge indicated in these tables are sometimes called “weighting coefficients” when deposition suppression discharge amounts are calculated.

When ink is landed on the same portion of the platen absorber M3041, the discharge amount of deposition suppression ink can be calculated by the following equation:

discharge amount of deposition suppression ink=(amount of landed deposition-prone ink×weighting coefficient+. . . +amount of landed deposition-prone ink×weighting coefficient)−amount of landed deposition suppression ink (1)

In the present embodiment, weighting coefficients are set as shown in FIGS. 11A and 11B. Accordingly, in the case of “environment 3”, the discharge amount of deposition suppression ink is obtained for each type of deposition suppression ink according to the following equations:

discharge amount of deposition suppression ink (clear ink)=amount of landed photo black ink×8+amount of landed yellow ink×2−amount of landed clear ink×1 (2)

discharge amount of deposition suppression ink (magenta ink)=amount of landed matte black ink×6−amount of landed magenta ink×1 (3)

The amounts of deposition suppression inks can be set in this manner.

### Control Example

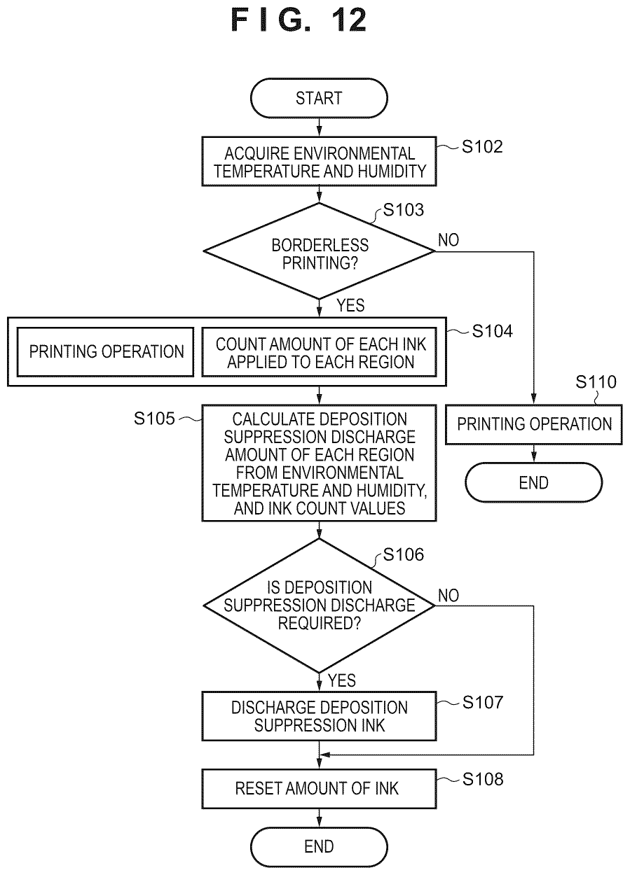

FIG. 12 is a flowchart showing a processing example executed by the CPU 300 of the control circuit, specifically a control example in a case where the printing apparatus 1 performs a printing operation. When a printing job is received from the host apparatus, the processing shown in FIG. 12 is started.

In step S102, the detection sensor 13 acquires the temperature/humidity information of the printing environment. Subsequently, it is determined whether borderless printing is set as a printing condition for the current printing job. If borderless printing is set, the process advances to step S104. If borderless printing is not set, the process advances to step S110. In step S110, a printing operation with respect to the image data of a printing job to print an image on a print medium is performed. The processing of the printing job is then completed.

In step S104, a printing operation with respect to the image data of the printing job to print an image on the print medium is performed and the amount of each ink discharged to a protrusion region is also measured. More specifically, a dot count (discharge count) is counted for each of regions A to D4 shown in FIG. 6. Upon completion of the printing operation, the process advances to step S105.

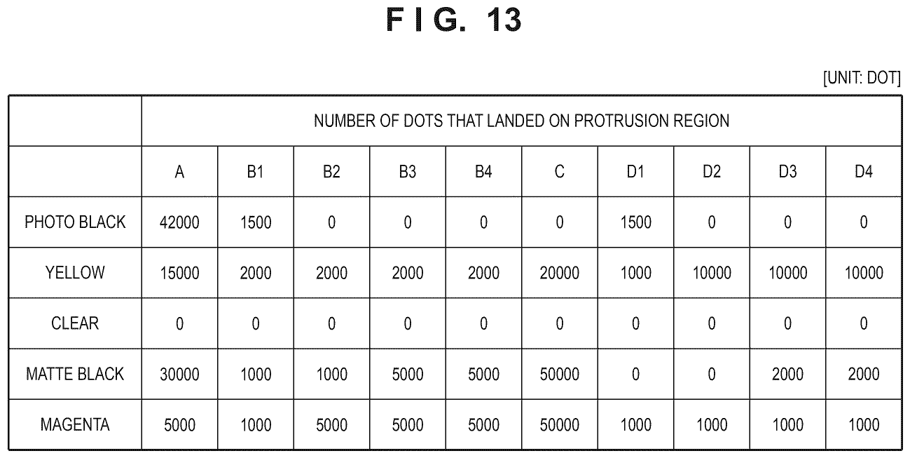

In step S105, a deposition suppression discharge amount is calculated from the temperature/humidity information acquired in step S102, the dot count of each color ink that landed on each region counted in step S105, and the weighting coefficient shown in FIG. 11. Assume that the temperature and the humidity were respectively 30° C. and 10%, and the ink amounts shown in FIG. 13 were respectively discharged to regions A to D4.

Regarding region A, a deposition suppression discharge amount is calculated based on equation (2), as follows:

required discharge amount of deposition suppression ink (clear ink)=amount of landed photo black ink: 42000 dots×8 +amount of landed yellow ink: 15000 dots×2−amount of landed clear ink: 0 dot=366000 dots (4)

If this amount of clear ink is discharged from all the 768 nozzles, then

discharge amount of deposition suppression ink: 366000 dots÷768 nozzles=476.6 (5)

If the fraction is rounded up, it is necessary to discharge 477 dots per nozzle from all the nozzles for clear ink to region A.

Subsequently, the discharge amount of magenta ink as a deposition suppression ink is calculated, based on equation (3), as follows:

required discharge amount of deposition suppression ink (magenta ink)=amount of landed matte black ink: 30000 dots×6−amount of landed magenta ink: 5000 dots=175000 dots (6)

If this amount of magenta ink is discharged from all the 768 nozzles, then

discharge amount of deposition suppression ink: 175000 dots÷768 nozzles=22.8 (7)

If the fraction is rounded up, it is necessary to discharge 23 dots per nozzle from all the nozzles for magenta ink to region A. Similar calculations are performed with respect to the remaining regions.

In step S106, it is determined for each region, from the calculation result obtained in step S105, whether deposition suppression discharge is required. If it is determined that deposition suppression discharge is required, the process advances to step S107; otherwise, the process advances to step S108. In the above case, since the required discharge amount of each deposition suppression ink, that is, each of clear ink and magenta ink, with respect to region A is a positive value, it is determined that each deposition suppression ink is required for deposition suppression discharge. If the calculation result is negative, it is determined that deposition suppression discharge is not required.

In step S107, the amount of deposition suppression ink calculated in step S105 is discharged to the region determined as a region requiring deposition suppression discharge. In this case, for example, first of all, clear ink is discharged to the region determined as a region requiring deposition suppression discharge. Regarding region A, as indicated by equation (5), 477 dots are discharged from each of all the nozzles. Subsequently, magenta ink is discharged onto the region determined as a region requiring deposition suppression discharge. As indicated by equation (7), 23 dots are discharged from each of all the nozzles onto region A.

Upon completion of the deposition suppression discharge, the count value of the discharge amount of ink onto each of regions A to D4 is reset in step S108. Thereafter, the processing is completed.

In the present embodiment, only clear ink is used to suppress the deposition of photo black ink and yellow ink, and only magenta ink is used to suppress the deposition of matter black ink. However, inks selected from inks of a plurality of colors as deposition suppression inks may be used. That is, in order to prevent specific inks of the inks used in the printing apparatus 1 from being unproportionally reduced, one type of ink may be selected and used from a plurality of types of deposition suppression inks. In this case, depending on a deposition-prone ink, some inks of a plurality of inks overlap, and other inks may differ from each other. For example, clear ink and light magenta ink are used to suppress the deposition of photo black ink and yellow ink, whereas magenta ink and light magenta ink are used to suppress the deposition of matte black ink.

In the present embodiment, since the amount (discharge amount) of each ink per dot is the same, the amount of ink required for deposition suppression discharge is calculated in the form of a dot count from the amount of ink that landed on the platen absorber M3041. Even if different discharge amounts are required for the respective colors, each discharge amount may be converted into a weight or volume as needed. Although the present embodiment has exemplified the arrangement having the platen absorber M3041 mounted on the platen M3040, the present disclosure can be applied to a printing apparatus having an arrangement without the platen absorber M3041.

According to the embodiment described above, it is possible to effectively perform deposition suppression by switching inks to be used for deposition suppression discharge after a printing operation depending on the landed ink.

### Second Embodiment

There is some type of ink that is not prone to cause deposition when it is used singly but causes deposition when it is mixed with another type of ink. For example, when two types of inks, each of which causes no deposition when it is landed on a platen absorber M3041 singly, are landed on the same portion on the platen absorber M3041, deposition sometimes occurs. Accordingly, although no deposition occurs immediately after a given printing job, deposition sometimes occurs later after the printing job. In addition, the amount of deposition after mixing of a plurality of types of inks sometimes differs from the sum of deposition amounts when each ink is landed singly.

One reason for the occurrence of such a phenomenon may be that when salt as an additive to a given ink is mixed with a color material of another type of ink, the color material deteriorates in dispersibility to cause aggregation and then deteriorates in fluidity. This tends to cause clogging in the platen absorber M3041, resulting in deposition. When such a phenomenon occurs, deposition suppression cannot be properly performed by any method considering only the deposition of a single type of ink.

In addition, if the count information of the amounts of ink that landed on the platen M3040 is reset at the end of each printing job as in the first embodiment, proper deposition suppression cannot sometimes be performed with respect to the deposition of ink that occurs across a plurality of printing jobs.

The present embodiment is configured to cope with the deposition of ink caused when a plurality of types of inks are mixed with each other. According to the present embodiment, it is possible to prevent deposition caused by the discharge of a deposition suppression ink despite its intention or to prevent wasteful consumption of a deposition suppression ink.

The present embodiment is also based on the assumption of using a total of eight types of inks including matte black ink, photo black ink, magenta ink, yellow ink, cyan ink, light magenta ink, light cyan ink, and clear ink containing no pigment and used for image quality improvement. However, the compositions of inks are not totally the same as in the first embodiment.

Experiment 3 described below was conducted to determine whether a given ink was a deposition-prone ink. A device that drops ink on the platen absorber M3041 is installed to intermittently drop target inks under a high-temperature/low-humidity environment. This makes it possible to determine whether the target ink is a deposition-prone ink by determining whether a sediment is formed on the platen absorber M3041 after a given prescribed drop count.

In experiment 3, ink was dropped on the platen absorber M3041 at 600 dpi×600 dpi (vertical×horizontal) and a density of 120 ng at 1-hour intervals under an environment with a temperature of 30° C. and a humidity of 10%. Ink dropping was executed 500 times.

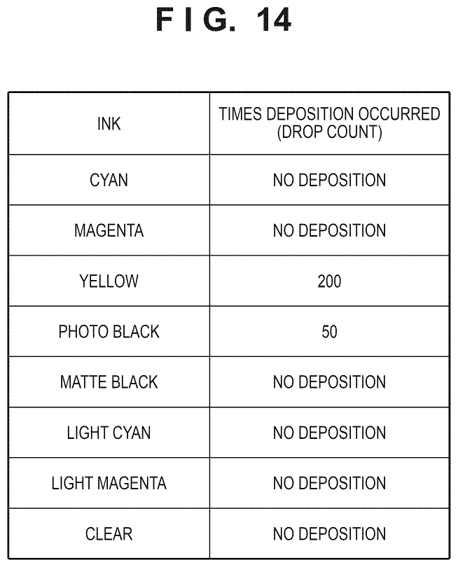

FIG. 14 shows, in a table form, an experiment result indicating whether sediments are formed after ink dropping. According to this result, inks that are deposited with smaller drop counts are more deposition-prone inks in the order of photo black ink>yellow ink.

Experiment 4 was then conducted to determine whether deposition occurred when different types of inks were mixed on the platen absorber M3041. A device that drops ink on the platen absorber M3041 is installed. An ink of one color is then dropped on the platen absorber M3041 under a high-temperature/low-humidity environment. An ink of another color is further dropped on the previous ink at the same portion. These two types of inks are repeatedly dropped at predetermined time intervals. It is then checked whether any ink that was not deposited in a single color ink experiment has caused deposition or any ink of one color that caused deposition singly has caused deposition faster. In this experiment, all combinations of test inks were dropped at 600 dpi×600 dpi (vertical×horizontal) and a density of 120 ng under an environment with a temperature of 30° C. and a humidity of 10%. Each type of ink was repeatedly dropped a total of 500 times at 1-hr intervals.

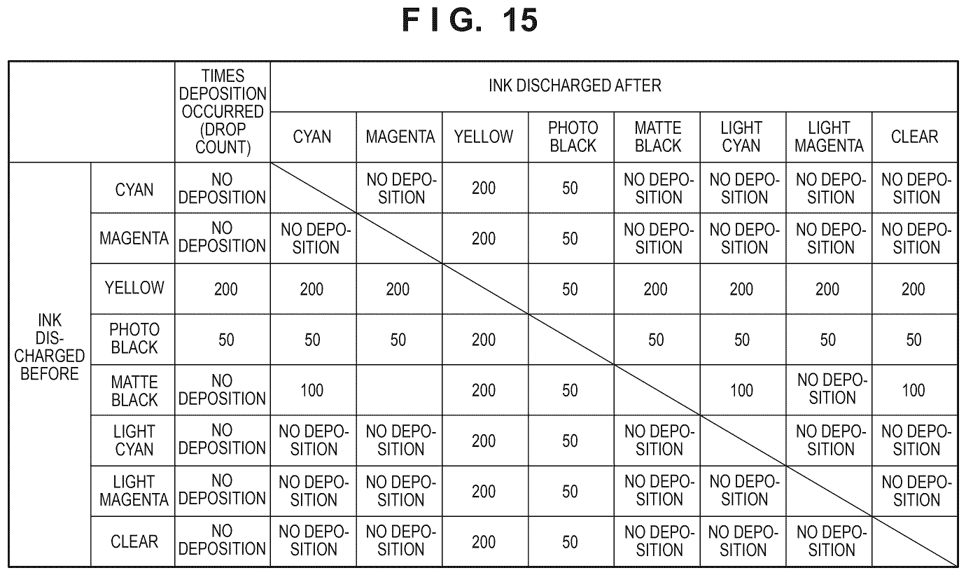

FIG. 15 shows the results of experiment 4. Any inks other than matte black ink did not exceed the results obtained when they were dropped singly. In contrast to this, it was found that matte black ink, which was not deposited singly, caused deposition when it was stacked on cyan ink, light cyan ink, or clear ink. This is thought to be because that when cyan ink, light cyan ink, or clear ink was mixed with matte black ink, the pigment dispersant decreased in dispersibility to cause aggregation, and the viscosity of matte black ink increased. In addition, an ink with poor resolubility is thought to be prone to deposition. Resolubility is the property of exhibiting better fluidity when an ink before an increase in viscosity is mixed with an ink after an increase in viscosity.

Experiment 4 indicates that when matte black ink is mixed with the same amount of cyan ink, light cyan ink, or clear ink on the platen M3040, ink deposition occurs. Experiment 5 was conducted to obtain the combining ratio of inks which most increases the deposition amount.

A device that drops ink on the platen absorber M3041 is installed. Under a high-temperature/low-humidity environment, an ink of the first color of a combination of two types of inks which causes deposition is dropped. Thereafter, an ink of the second color is dropped. Tests are conducted while the ratio between the amount of dropped ink of the first color and the amount of dropped ink of the second color is changed from 1:9 to 9:1. An operation of dropping inks of two colors is repeatedly executed as one set at predetermined time intervals. The height of each sediment after the execution of tests by a predetermined set count is used to determine the combining ratio of inks which causes the highest deposition.

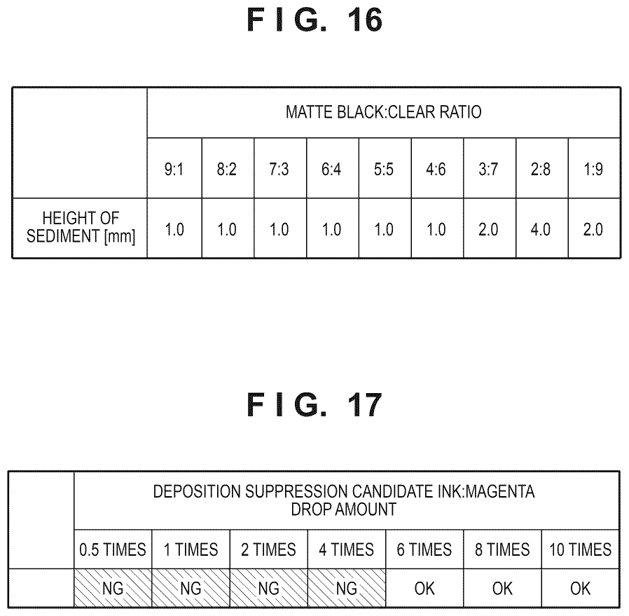

FIG. 16 shows the test results obtained by using combinations of matte black ink and clear ink. Inks of the two colors were dropped at 600 dpi×600 dpi (vertical×horizontal) and a density of 120 ng in total under an environment with a temperature of 30° C. and a humidity of 10%. FIG. 16 shows the heights of sediments as the result of repeatedly dropping the inks at 1-hr intervals a total of 500 times.

These results indicate that the highest sediment height is recorded at matte black ink: clear ink=2:8, that is, when matte black ink is mixed with clear ink 4 times the amount of matte black ink. Although not shown, similar tests were also conducted with respect to cyan ink and light cyan ink. The tests indicate that deposition occurs most easily when matte black ink is mixed with cyan ink or light cyan ink 4 times the amount of matte black ink. Similar tests were executed at different temperatures and humidities. The tests indicate that deposition occurs when the humidity is 40% or less.

Experiment 6 was then conducted to determine which ink was effective when dropped to suppress deposition caused by mixing of matte black ink and clear ink. A device that drops ink on the platen absorber M3041 is installed. Two types of inks that cause deposition when they are mixed are dropped at a ratio that causes deposition most easily under a high-temperature/low-humidity environment. The ink dropping method is the same as in experiment 5. Immediately after the dropping operation, a deposition suppression ink candidate is dropped. In order to determine how many times the amount of deposition-prone inks the deposition suppression ink candidate is to be dropped, tests are conducted at a plurality of levels concerning the amount of deposition suppression ink dropped. Dropping of the two types of deposition-prone inks and dropping of a deposition suppression ink candidate are performed as one set, and the same step is repeatedly executed at predetermined time intervals.

In this experiment, the ratio of inks of two colors to be deposited, that is, matte black ink: clear ink=2:8, and a deposition suppression ink candidate is magenta ink, which caused no deposition even when it was mixed with matte black in experiment 4 described above. Matte black ink is dropped at a density of 24 ng and clear ink is deposited at a density of 96 ng on the platen absorber M3041 at 600 dpi×600 dpi (vertical ×horizontal) under an environment with a temperature of 30° C. and a humidity of 10%. Immediately after this operation, magenta ink is dropped in an amount 0.5 times, 1 time, 2 times, 4 times, 6 times, 8 times, and 10 times the total amount of matte black ink and clear ink. The above step was repeatedly performed a total of 500 times.

FIG. 17 shows the experiment result. When deposition has occurred on the platen absorber M3041 at the end of 500 tests, “NG” is recorded, whereas when no deposition has occurred, “OK” is recorded. This result indicates that deposition has occurred when the amount of magenta ink dropped is 4 or less times the total amount of matte black ink and clear ink, and no deposition has occurred when the amount of magenta ink dropped is 6 or more times the total amount. Accordingly, this indicates that the amount of ink required for deposition suppression discharge is 6 times the total amount.

Of the types of inks in the present embodiment, photo black ink and yellow ink singly cause deposition, and hence the required amount of deposition suppression ink can be measured by the same method as in the first embodiment.

When an ink (cyan ink, light cyan ink, or clear ink) that is deposited when it is mixed with matte black ink is landed on the same portion of the platen absorber M3041, a deposition suppression discharge amount is obtained by the following equations.

First of all, [MBK] and [C·LC·CL] are defined as follows:
group 1:[MBK]=amount of matte black ink that landed on platen absorber M3041
group 2:[C·LC·CL]=total amount of cyan ink, light cyan ink, and clear ink that landed on platen absorber M3041
[MBK] is compared with the amount 4 times [C·LC·CL], and a deposition suppression discharge amount is obtained by multiplying the smaller amount by 6. [C·LC·CL] is multiplied by 4 because the largest deposition occurs when [MBK] and [C·LC·CL] are mixed at a ratio of 2:8. That is, when [C·LC·CL] is 4 times [MBK], they react with each other most efficiently. This is also because an excess amount with respect to the above amount makes little contribution to deposition.

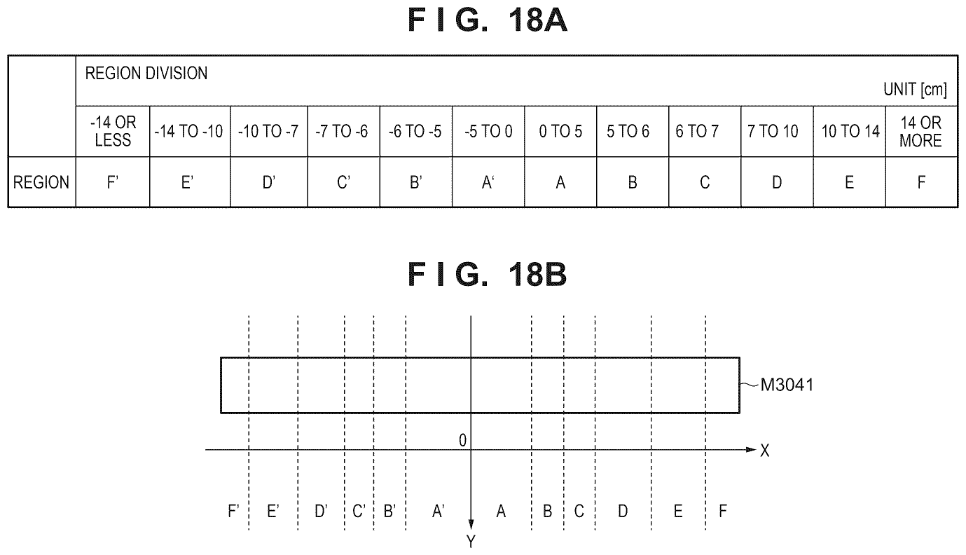

The measurement of the discharge amount of ink in a protrusion region will be described next. In the printing apparatus 1 according to the present embodiment, when print media are fed, the central position of each print medium in the X direction remains the same regardless of the change of the size of the print medium, which coincides with the central position of the platen absorber M3041 in the X direction. The platen absorber M3041 is divided into 12 regions with reference to the central position, as shown in FIGS. 18A and 18B.

The positions of the 12 regions are defined by positive values when they are located on the right side when facing the printing apparatus 1, with the central position of a fed print medium being defined as 0. Regions A and A′ are respectively located on the left end and the right end at the time of printing on an L size print medium. Regions B and B′ are respectively located on the left end and the right end at the time of printing on a KG size print medium. Regions C and C′ are respectively located on the left end and the right end at the time of printing on a 2L size print medium. Regions D and D′ are respectively located on the left end and the right end at the time of printing on an A5 size print medium. Regions E and E′ are respectively located on the left end and the right end at the time of printing on an A4 size print medium. Regions F and F′ are respectively located on the left end and the right end at the time of printing on an A3 size print medium.

In executing borderless printing, if the humidity is equal to or less than 40% at which deposition can occur, the amount of ink that landed on each region is counted for each group defined below:
group 1 [MBK]: matte black ink
group 2 [C·LC·CL]: cyan ink, light cyan ink, and clear ink
The counted ink amounts are saved in the nonvolatile memory 318 so as to be saved even while the power is off.

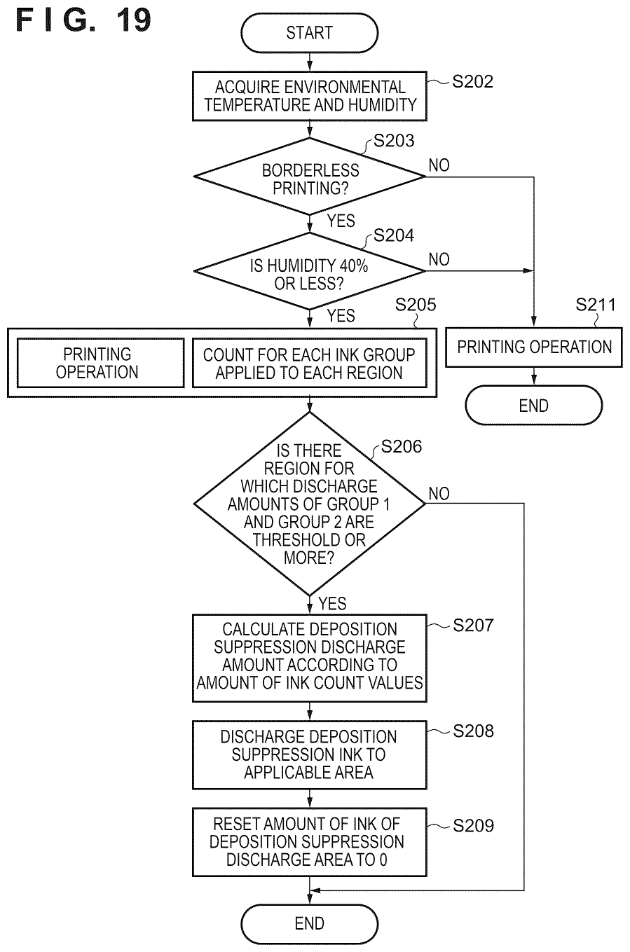

FIG. 19 shows an example of the processing executed by the CPU 300 of a control circuit according to the present embodiment, particularly a flowchart showing an example of control when a printing apparatus 1 performs a printing operation. Upon reception of a printing job from a host apparatus, the CPU 300 starts the processing in FIG. 19.

In step S202, the detection sensor 13 acquires the temperature/humidity information of a printing environment. Subsequently, the CPU 300 determines whether borderless printing is set as a printing condition for the current printing job. If borderless printing is set, the process advances to step S204. If borderless printing is not set, the process advances to step S211. In step S211, the CPU 300 performs a printing operation with respect to the image data of the printing job to print an image on a print medium. The CPU 300 then terminates the processing of the printing job.

In step S204, the CPU 300 determines whether the humidity information acquired in step S202 indicates 40% or less. If the humidity is 40% or less, the process advances to step S205. If the humidity is not 40% or less, the process advances to step S211. In the present embodiment, it is regarded that if the humidity is high, ink deposition does not occur much.

In step S205, the CPU 300 performs a printing operation with respect to the image data of the printing job to print an image on the print medium and also measures the amount of each ink discharged to each protrusion region. More specifically, the CPU 300 counts a dot count (discharge count) for each of regions A to F and A′ to F′ shown in FIGS. 18A and 18B and each of groups 1 and 2 of inks. When the printing operation ends, the process advances to step S206.

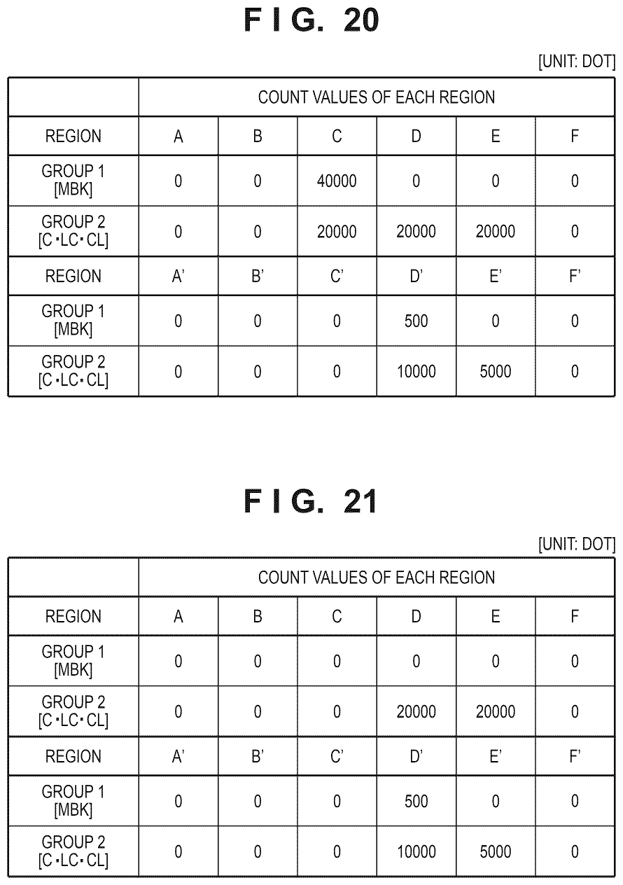

In step S206, the CPU 300 determines whether there is any region in which the discharge amounts of group 1 ([MBK]) and group 2 ([C·LC·CL]) each are equal to or more than a threshold. If there is such a region, the process advances to step S207; otherwise, the processing is terminated. Assume that the threshold is 10000 dots in this case. FIG. 20 shows, as an example, the amounts of inks discharged to the respective regions at a temperature of 30° C. and a humidity of 30%. The unit is dot count. As described above, regions A to F and A′ to F′ correspond to the sizes of print media. The count values recorded in a plurality of regions are count values of inks landed in a past printing job. This indicates that some regions include count values that have not been reset.

In the example shown in FIG. 20, the discharge amounts of group 1 ([MBK]) and group 2 ([C·LC·CL]) in region C are both equal to or more than the threshold. Accordingly, region C is a target for deposition suppression discharge. In step S207, the CPU 300 calculates a deposition suppression discharge amount. The calculation method for this is the same as that described above. When this method is applied to the example of FIG. 20,
group 1: [MBK] =40000 dots
group 2: [C·LC·CL]×4=20000 dots×4=80000 dots
A deposition suppression discharge amount is obtained by multiplying the smaller value by 6.

Since the smaller value is the value of group 1:[MBK], a deposition suppression discharge amount is calculated as follows:

discharge amount=[MBK]×6=400000 dots×6=240000 dots

Since the number of nozzles for magenta ink as a deposition suppression ink is 768, a discharge amount for deposition suppression discharge per nozzle is given by:

discharge amount=240000 dots÷768 nozzles=312.5 dots

The fraction is rounded up, and each of all the magenta nozzles discharges 313 dots.

In step S208, the CPU 300 moves a carriage M4000 to set the magenta nozzle array above region C that has become a target for deposition suppression discharge, and discharges magenta ink. Thereafter, in step S209, the CPU 300 resets the amount of ink in region C having undergone deposition suppression discharge to 0. FIG. 21 shows the count value as a result of this processing. Since no deposition suppression discharge has been executed for regions D, E, D′, and E′, the count values are maintained without being reset. The processing is then terminated.

As has been described above, according to the present embodiment, it is possible to effectively perform deposition suppression discharge while coping with the problem that an ink of the type that is not deposited singly causes deposition when it is mixed with another type of ink. Although the present embodiment has exemplified the case where when two or more types of inks are combined, deposition occurs, the first embodiment and the second embodiment can be combined.

Although each embodiment described above has exemplified the case where as two or more pigment inks are combined, the deposition amount increases, a similar phenomenon occurs in the case of dye inks. Assume that an image such as a black character is to be printed on a yellow background. In this case, if black ink oozes on a yellow background portion, the character quality deteriorates. In order to prevent this, ink compositions are sometimes prescribed as follows. The basic configuration of dye ink includes a dye, a solvent, a surfactant, and an additive. Black ink contains Mg ions (Mg2+) as an additive. When Mg ions are mixed with the dye contained in yellow ink, the fluidity deteriorates. Using this property prevents image quality deterioration caused by oozing of ink in a case where yellow ink is printed adjacent to an area where a large amount of black ink is printed on a print medium. Note, however, that if black ink and yellow ink are mixed with each other on the platen absorber at the time of borderless printing, the fluidity sometimes deteriorates to easily cause ink deposition. As described above, deposition occurs not only when two or more types of pigment inks are mixed with each other but also when two or more types of dye inks are mixed with each other. The present embodiment can also be applied to a printing apparatus using dye inks.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-176735, filed Oct. 8, 2024, which is hereby incorporated by reference herein in its entirety.

What is claimed is:

1. A printing apparatus comprising:
a printing unit configured to discharge a plurality of types of liquids to a print medium;
a platen arranged to face the printing unit and configured to support the print medium; and
a control unit configured to control the printing unit,
wherein the control unit executes discharge control to discharge, to a liquid discharged to the platen in a printing operation, a liquid of a type different from the liquid discharged to the platen after the printing operation,
the discharge control is performed such that a second type of liquid is discharged to a first type of liquid discharged to the platen in the printing operation, and a fourth type of liquid is discharged to a third type of liquid discharged to the platen in the printing operation,
the second type of liquid is a liquid having a higher deposition suppression effect for a component of the first type of liquid than the fourth type of liquid, and
the fourth type of liquid is a liquid having a higher deposition suppression effect for a component of the third type of liquid than the second type of liquid.

2. The apparatus according to claim 1, wherein in accordance with a type of liquid discharged to the platen in the printing operation, a type of liquid discharged to the liquid discharged to the platen in the discharge control is selected.

3. The apparatus according to claim 1, wherein in the discharge control, a liquid selected from a plurality of types of liquids including the second type of liquid is discharged to the first type of liquid discharged to the platen in the printing operation.

4. The apparatus according to claim 1, wherein the plurality of types of liquids include a plurality of types of liquids used in the discharge control and a plurality of liquids not used in the discharge control.

5. The apparatus according to claim 4, wherein if liquids discharged to the platen in the printing operation are a plurality of types of liquids used in the discharge control, the discharge control is not performed for the liquids.

6. A printing apparatus comprising:
a printing unit configured to discharge a plurality of types of liquids to a print medium;
a platen arranged to face the printing unit and configured to support the print medium; and
a control unit configured to control the printing unit,
wherein the control unit executes discharge control to discharge a liquid to a predetermined region of the platen after a printing operation, and
it is determined whether the discharge control is to be executed based on an amount of a plurality of types of liquids discharged to the predetermined region before completion of the printing operation.

7. The apparatus according to claim 6, wherein the amount of the plurality of types of liquids discharged to the predetermined region before completion of the printing operation is reset after the discharge control.

8. The apparatus according to claim 6, wherein the discharge control is executed if an amount of a first liquid discharged to the predetermined region before an end of the printing operation is not less than a first threshold, and an amount of a second liquid discharged to the predetermined region before completion of the printing operation is not less than a second threshold.

9. The apparatus according to claim 6, wherein the discharge control is executed if an amount of a first liquid discharged to the predetermined region before completion of the printing operation is not less than a first threshold, and a total amount of an amount of a second liquid and an amount of a third liquid discharged to the predetermined region before completion of the printing operation is not less than a second threshold.

10. The apparatus according to claim 8, wherein an amount of liquid discharged in the discharge control is set based on an amount of the first liquid discharged to the predetermined region before completion of the printing operation.

11. The apparatus according to claim 8, wherein an amount of liquid discharged in the discharge control is set based on an amount of the second liquid discharged to the predetermined region before completion of the printing operation.

12. The apparatus according to claim 9, wherein an amount of liquid discharged in the discharge control is set based on a total amount of an amount of the second liquid and an amount of the third liquid discharged to the predetermined region before completion of the printing operation.

13. The apparatus according to claim 8, wherein an amount of liquid discharged in the discharge control is set based on a smaller one of an amount of the first liquid and an amount of the second liquid discharged to the predetermined region before completion of the printing operation.

14. The apparatus according to claim 9, wherein an amount of liquid discharged in the discharge control is set based on a smaller one of an amount of the first liquid and a total amount of an amount of the second liquid and an amount of the third liquid discharged to the predetermined region before completion of the printing operation.

15. The apparatus according to claim 6, wherein in the discharge control, a liquid configured to suppress deposition of a liquid in the predetermined region is discharged to the predetermined region.

16. A control method for a printing apparatus including a printing unit configured to discharge a plurality of types of liquids to a print medium and a platen arranged to face the printing unit and configured to support the print medium, the method comprising
executing discharge control to discharge, to a liquid discharged to the platen in a printing operation, a liquid of a type different from the liquid discharged to the platen after the printing operation,
wherein in the discharge control, a second type of liquid is discharged to a first type of liquid discharged to the platen in the printing operation, and a fourth type of liquid is discharged to a third type of liquid discharged to the platen in the printing operation,
the second type of liquid is a liquid having a higher deposition suppression effect for a component of the first type of liquid than the fourth type of liquid, and
the fourth type of liquid is a liquid having a higher deposition suppression effect for a component of the third type of liquid than the second type of liquid.

17. A control method for a printing apparatus including a printing unit configured to discharge a plurality of types of liquids to a print medium and a platen arranged to face the printing unit and configured to support the printing unit, the method comprising
executing discharge control to discharge a liquid to a predetermined region of the platen after a printing operation,
wherein it is determined whether the discharge control is to be executed based on an amount of a plurality of types of liquids discharged to the predetermined region before completion of the printing operation.

18. A non-transitory computer-readable storage medium storing a program that causes a computer to execute a control method for a printing apparatus including a printing unit configured to discharge a plurality of types of liquids to a print medium and a platen arranged to face the printing unit and configured to support the print medium, the control method comprising
executing discharge control to discharge, to a liquid discharged to the platen in a printing operation, a liquid of a type different from the liquid discharged to the platen after the printing operation,
wherein in the discharge control, a second type of liquid is discharged to a first type of liquid discharged to the platen in the printing operation, and a fourth type of liquid is discharged to a third type of liquid discharged to the platen in the printing operation,
the second type of liquid is a liquid having a higher deposition suppression effect for a component of the first type of liquid than the fourth type of liquid, and
the fourth type of liquid is a liquid having a higher deposition suppression effect for a component of the third type of liquid than the second type of liquid.

19. A non-transitory computer-readable storage medium storing a program that causes a computer to execute a control method for a printing apparatus including a printing unit configured to discharge a plurality of types of liquids to a print medium and a platen arranged to face the printing unit and configured to support the printing unit, the control method comprising
executing discharge control to discharge a liquid to a predetermined region of the platen after a printing operation,
wherein it is determined whether the discharge control is to be executed based on an amount of a plurality of types of liquids discharged to a predetermined region before completion of the printing operation.
